(19) United States
(12) Patent Application Publication
(10) Pub. No.: US 2026/0100457 A1
(43) Pub. Date: Apr. 9, 2026

(54) Battery Cell, and Battery Pack and Vehicle Including the Same

(71) Applicant: LG Energy Solution, Ltd., Seoul (KR)

(72) Inventors: Tae-Rim Hong, Daejeon (KR); Sung-Min Cho, Daejeon (KR); Do-Gyun Kim, Daejeon (KR); Jun-Ho Baek, Daejeon (KR); Seung-Hun Lee, Daejeon (KR)

(73) Assignee: LG Energy Solution, Ltd., Seoul (KR)

(21) Appl. No.: 19/346,843

(22) Filed: Oct. 1, 2025

(30) Foreign Application Priority Data
Oct. 7, 2024 (KR) 10-2024-0136004

(51) Int. Cl. H01M 50/152; B60L 50/64; H01M 50/107; H01M 50/169; H01M 50/179; H01M 50/342; H01M 50/533; H01M 50/627

(52) U.S. Cl. CPC H01M 50/152; H01M 50/107; H01M 50/169; H01M 50/179; H01M 50/3425; H01M 50/533; H01M 50/627; B60L 50/64; H01M 2200/20; H01M 2220/20

(57) ABSTRACT

A battery cell may include an electrode assembly, a cell housing, and a can lid. The cell housing may include a sidewall portion, an opening at a first end of the cell housing in an axial direction, and a bottom portion at a second end of the cell housing in the axial direction. The cell housing is configured to accommodate the electrode assembly. The can lid may include an edge portion and an electrode coupling portion. The can lid is configured to cover the opening of the cell housing. The electrode coupling portion of the can lid extends further into an interior of the cell housing in an axial direction than the edge portion of the can lid. The electrode coupling portion contacts the electrode assembly and the edge portion of the can lid is spaced apart from the electrode assembly along the axial direction.

### CROSS-REFERENCE TO RELATED APPLICATIONS

This application claims priority under 35 U.S.C. § 119 to Korean Patent Application No. 10-2024-0136004 filed on Oct. 7, 2024, the entire contents of which are incorporated herein by reference.

### TECHNICAL FIELD

The present disclosure relates to a battery cell, and a battery pack and a vehicle including the same. The present disclosure also relates to a method for manufacturing a battery cell.

### BACKGROUND

There is an increasing demand for a battery cell in the form of a metal can that may be used in a vehicle battery pack. The shape of the metal can may be prismatic or cylindrical. A cylindrical battery cell may have a structure in which a jelly-roll-shaped electrode assembly is accommodated inside the cylindrical can and has the advantage of being more resistant to shock or temperature changes than a pouch-type battery cell.

### SUMMARY

### Technical Problem

The process of manufacturing a battery cell using a cylindrical can may include a step of manufacturing a cell housing by deep drawing a metal sheet to mold a circular bottom portion and a circular tubular side wall portion connected thereto. The process may include accommodating an electrode assembly inside the cell housing, and then covering the open end of the cell housing with a can lid. The can lid may be joined to the cell housing by welding or a beading and crimping method.

FIG. 1 illustrates a case where a side wall portion of a cell housing and a can lid are welded in a conventional battery cell.

When the side wall portion 1 of the cell housing and the can lid 4 are butt welded, for example by Seam welding (SMW), there is an advantage that the internal space of the cell housing may be utilized better than when finished with a beading and crimping technique, and accordingly, energy density may be increased. However, if there is a gap between the side wall portion 1 of the cell housing and the can lid 4, the welding laser may be incident into the internal space of the cell housing and damage the electrode assembly 6. Even if welding is performed in that scenario, the thickness of the welded portion may be reduced and thus the welded portion may not have sufficient welding strength. If precision processing is required to reduce the tolerance so that there is no gap between the side wall portion 1 of the cell housing and the can lid 4, the cost of manufacturing battery cells increases. And, when tack welding is required to properly fix the can lid 4 and the side wall portion 1 of the cell housing during welding, ease of assembly and productivity decrease and cost increases. Therefore, it is important to improve the structure between the edge of the can lid 4 and the side wall portion 1 of the cell housing so they may be assembled without a gap, thereby omitting the tack welding and preventing damage to the electrode assembly 6.

Additionally, in the conventional battery cell illustrated in FIG. 1, welding, such as Can-Anode current collector welding (CAW), between the negative electrode current collector plate 8 and the side wall portion 1 of the cell housing is also required. Conventional battery cells are limited in that the welding (CAW) is used in addition to butt welding (SMW) and a component called the negative electrode current collector plate 8 is required in addition to the can lid 4.

The present disclosure is designed to solve the above-described problems, and therefore aspects of the present disclosure are directed to providing a battery cell capable of increasing ease of assembly and productivity when butt welding a side wall portion of a cell housing and a can lid.

Aspects of the present disclosure are also directed to providing a battery cell capable of further utilizing the space inside the battery cell and preventing damage to an electrode assembly when butt welding a can lid to an opening of a cell housing.

Aspects of the present disclosure are also directed to providing a battery pack and a vehicle including such a battery cell.

### Technical Solution

A battery cell according to the present disclosure for solving the above-described problem includes an electrode assembly, a cell housing, and a can lid. The cell housing comprises a sidewall portion, an opening at a first end of the cell housing in an axial direction, and a bottom portion at a second end of the cell housing in the axial direction. The cell housing is configured to accommodate the electrode assembly therein. The can lid may include an edge portion and an electrode coupling portion. The can lid is configured to be positioned to cover the opening of the cell housing. The electrode coupling portion of the can lid extends further into an interior of the cell housing in the axial direction than the edge portion of the can lid. The electrode coupling portion of the can lid contacts the electrode assembly and the edge portion of the can lid is spaced apart from the electrode assembly along the axial direction.

In one or more aspects, the edge portion of the can lid is joined to the side wall portion of the cell housing at the first axial end of the cell housing.

In one or more aspects, the can lid is electrically connected to the side wall portion of the cell housing.

In one or more aspects, the can lid comprises a plurality of electrode coupling portions and each of the plurality of electrode coupling portions contacts the electrode assembly.

In one or more aspects, the plurality of electrode coupling portions are spaced apart from each other in a circumferential direction.

In one or more aspects, the can lid comprises a plurality of bridges and each bridge of the plurality of bridges is between adjacent electrode coupling portions of the plurality of electrode coupling portions in the circumferential direction.

In one or more aspects, the plurality of the electrode coupling portions are arranged rotationally symmetrically about a center of the can lid.

In one or more aspects, the can lid further comprises an injection port at a center of the can lid.

In one or more aspects, the can lid further comprises a flat portion surrounding the injection port, and wherein the flat portion is between the injection port and the electrode coupling portion in a radial direction.

In one or more aspects, the can lid further comprises a vent notch portion between the electrode coupling portion and the edge portion in a radial direction.

In one or more aspects, the vent notch portion is on a surface of the can lid that faces away from the electrode assembly in the axial direction.

In one or more aspects, the edge portion of the can lid comprises a mating surface, a curved surface, and an inclined surface that form a U-shaped bent portion.

In one or more aspects, an outer edge of the can lid in a radial direction comprises the mating surface.

In one or more aspects, the mating surface extends in the axial direction and the mating surface is in direct contact with an inner circumferential surface of the sidewall portion of the cell housing.

In one or more aspects, the electrode assembly comprises a first electrode, a second electrode, and a separator interposed between the first electrode and the second electrode.

In one or more aspects, the first electrode comprises a first uncoated portion, the second electrode comprises a second uncoated portion, and the second uncoated portion of the second electrode is directly connected to the electrode coupling portion of the can lid.

In one or more aspects, the bottom portion of the cell housing comprises a through hole, a terminal extends through the through hole of the bottom portion of the cell housing, and the terminal is electrically connected to the first uncoated portion of the first electrode.

In one or more aspects, the battery cell is a cylindrical battery cell.

In one or more aspects, a battery pack may comprise the battery cell.

In one or more aspects, a vehicle may comprise the battery pack.

### Advantageous Effects

According to one aspect of the present disclosure, the can lid may be pressed into the inner circumferential surface of the side wall portion of the cell housing to reduce the occurrence of a gap between the side wall portion of the cell housing and the edge of the can lid.

According to one aspect of the present disclosure, ease of assembly and productivity may be improved through pressure insertion of the can lid.

According to one aspect of the present disclosure, the edge of the can lid may be closely connected to the inner circumferential surface of the cell housing, so that there is no need for tack welding and the laser of the butt welding is not incident into the internal space of the cell housing, thereby causing no damage to the electrode assembly. Additionally, this may prevent concern about the thickness of the welded portion being insufficient, which may reduce the strength of the weld.

According to one aspect of the present disclosure, the edge of the can lid may be configured as a U-shaped bent portion, and this U-shaped bent portion may be spaced apart from the electrode assembly. Accordingly, welding heat may be prevented from being directly conducted to the electrode assembly, thereby avoiding thermal damage to the electrode assembly. Additionally, since the U-shaped bent portion and the electrode assembly are not in physical contact with each other, there is no impact on the electrode assembly, particularly the second uncoated portion of the second electrode, which may prevent cracking or kinking in the second uncoated portion.

According to another aspect of the present disclosure, a bond between the can lid and the cell housing is simplified, and there is no need to use a current collector plate when electrically connecting the electrode assembly to the can lid. This may reduce the number of parts and assembly man-hours necessary for producing the battery cell. This may also maximize the internal volume of the battery cell, thereby increasing energy density.

According to still another aspect of the present disclosure, the can lid may have a flat surface that contacts the electrode assembly, and when the can lid and the electrode assembly are directly welded, the can lid may be stably and evenly joined to the electrode assembly, thereby improving the welding quality with the electrode assembly.

According to still another aspect of the present disclosure, a battery cell using butt welding is provided, so that energy density may be increased compared to a battery cell using a beading and crimping method.

### BRIEF DESCRIPTION OF THE DRAWINGS

The accompanying drawings illustrate aspects of the present disclosure and together with the disclosure, serve to provide a further understanding of the technical features of the present disclosure. Thus, the present disclosure is not limited to the aspects depicted in the drawings.

FIG. 1 is a partial side cross-sectional view of a conventional battery cell illustrating where a side wall portion of a cell housing and a can lid are butt welded.

FIG. 2 is a perspective view schematically depicting a battery cell according to an aspect of the present disclosure.

FIG. 3 is a side cross-sectional view of a battery cell according to an aspect of the present disclosure.

FIG. 4 is a plan view of a can lid included in a battery cell according to an aspect of the present disclosure.

FIG. 5A is a side cross-sectional view taken along section line A-A′ in FIG. 4.

FIG. 5B is a side cross-sectional view showing, in an enlarged manner, a region around an injection port of a battery cell according to an aspect of the present disclosure.

FIG. 6 is a side cross-sectional view of a battery cell according to an aspect of the present disclosure.

FIG. 7 is a perspective view of a can lid included in a battery cell according to an aspect of the present disclosure.

FIG. 8 is a plan view of a can lid included in a battery cell according to an aspect of the present disclosure.

FIG. 9 is a side cross-sectional view taken along section line A-A′ in FIG. 8.

FIG. 10 is a cross-sectional view of a can lid included in a battery cell according to an aspect of the present disclosure.

FIG. 11 is an upper perspective view of the can lid shown in FIG. 10.

FIG. 12 is a lower perspective view of the can lid shown in FIG. 10.

FIG. 13 is a perspective view schematically depicting a battery pack according to an aspect of the present disclosure.

FIG. 14 is a schematic view for describing a vehicle including a battery pack according to an aspect of the present disclosure.

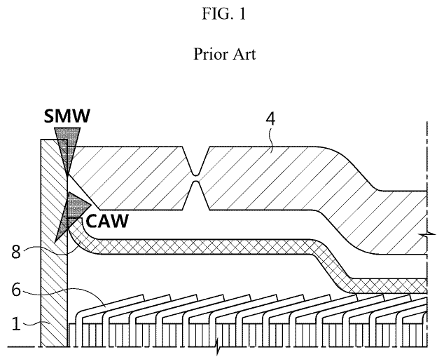

### DETAILED DESCRIPTION

Hereinafter, aspects of the present disclosure will be described in detail with reference to the accompanying drawings. Prior to the description, it should be understood that the terms used in the specification and the appended claims should not be construed as limited to general and dictionary meanings, but interpreted based on the meanings and concepts corresponding to technical aspects of the present disclosure on the basis of the principle that the inventor is allowed to define terms appropriately for the best explanation.

Therefore, the aspects described in this specification and the aspects illustrated in the drawings are only some of the aspects of the present disclosure and are not intended to entirely represent the technical features of the present disclosure. Accordingly, it should be understood that various equivalents and modifications may be made thereto at the time of filing the present application.

Additionally, the present disclosure includes various aspects. For each aspect, duplicate descriptions of substantially identical or similar configurations will be omitted, and differences will be mainly described.

Meanwhile, terms indicating directions such as upper, lower, left, right, front, and rear may be used in the present disclosure, but these terms are only for convenience of description in distinguishing relative directions from one another. It is therefore to be understood that the terms may vary depending on the position of a reference object or an observer, and such terms are not to be interpreted as being limited to, for example, a particular orientation with respect to the direction of gravity.

For convenience of description, the direction along the longitudinal direction of the winding axis of the electrode assembly 100 wound in the form of a jelly-roll in the present specification is referred to as the axial direction. And, the direction surrounding the winding axis is referred to as the circumferential direction or the perimeter direction. And, the direction closer to or away from the winding axis is referred to as the radial direction.

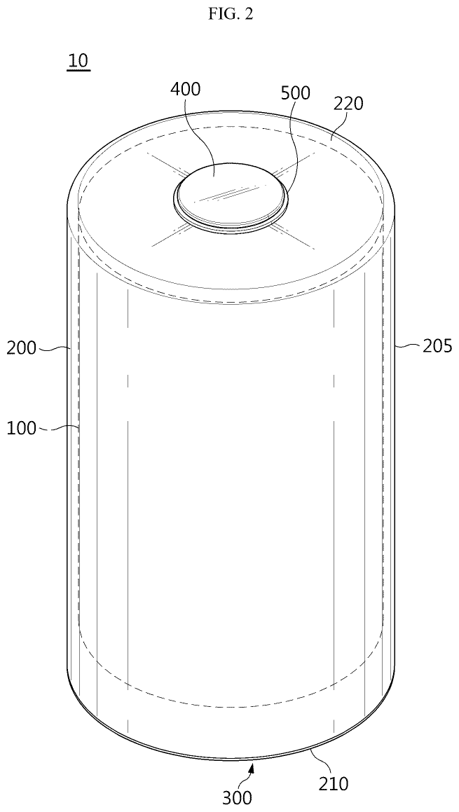

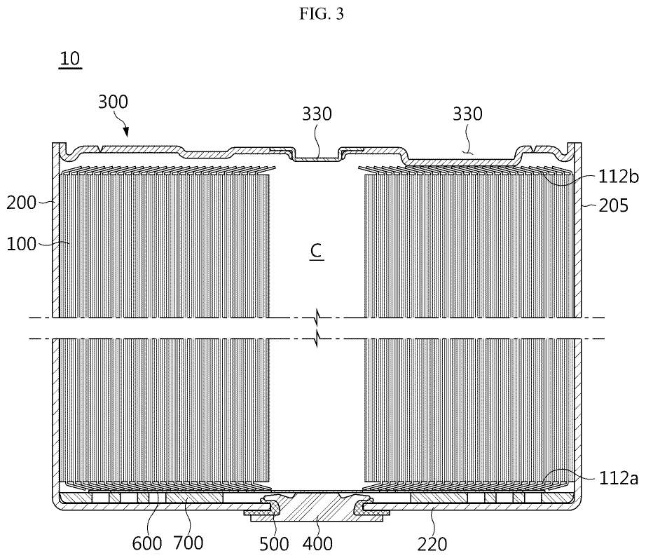

FIG. 2 is a perspective view schematically depicting a battery cell according to an aspect of the present disclosure, and FIG. 3 is a side cross-sectional view of a battery cell according to an aspect of the present disclosure.

Referring to FIGS. 2 and 3, a battery cell 10 according to an aspect of the present disclosure may include an electrode assembly 100, a cell housing 200, and a can lid 300.

The battery cell 10 may be a secondary battery configured to be chargeable and dischargeable. For example, the battery cell 10 may be a cylindrical battery cell.

The electrode assembly 100 may include a first electrode, a second electrode, and a separator interposed therebetween. The first electrode may have a first polarity, and the second electrode may have a second polarity that is opposite to the first polarity. For example, the first polarity may be positive, and the second polarity may be negative. In the following description the first electrode may be referred to as a positive electrode and the second electrode may be referred to as a negative electrode. However, it should be understood that in any of the aspects described herein the described polarity of the first and second electrodes may be modified or reversed.

The electrode assembly 100 may be formed by stacking the first electrode and the second electrode and the separator interposed therebetween to form a stack. The stack of the first electrode, the second electrode, and the separator of the electrode assembly 100 may be wound around a winding center hole (core) C to form a jelly-roll. The electrodes (the first electrode and the second electrode) may each have an uncoated portion 112a, 112b that does not include an active material. The uncoated portions 112a, 112b may be located along a longitudinal edge of each electrode prior to winding, such that the uncoated portions 112a, 112b are positioned at an axial end of the electrode assembly 100 after winding. The uncoated portion 112a, 112b may have a plurality of notched foil tabs. Additional details regarding the electrodes with their uncoated portions and notched tabs may be found in U.S. Patent Application Publication No. 2023/0395950 (hereinafter “the incorporated '950 Publication”), the entire contents of which are incorporated by reference herein.

For example, the first electrode may comprise a positive electrode plate and a positive electrode active material. The positive electrode active material may be applied onto one surface or both opposing surfaces of the positive electrode plate. The positive electrode plate may comprise a first uncoated portion 112a that is not coated with the positive electrode active material. The first uncoated portion 112a may be formed on a side of the positive electrode plate that extends parallel to the winding direction of the stack. The first uncoated portion 112a may project axially beyond an edge of the separator while forming a plurality of winding turns about the center MA of the electrode assembly 100, such that the first uncoated portion 112a may be exposed and may be used as an electrode tab in itself.

The second electrode may comprise a negative electrode plate and a negative electrode active material. The negative electrode active material may be applied onto one surface or both opposing surfaces of the negative electrode plate. The negative electrode plate may comprise a second uncoated portion 112b that is not coated with the negative electrode active material. The second uncoated portion 112b may be formed on a side of the negative electrode plate that extends parallel to the winding direction of the stack. The second uncoated portion 112b may project axially beyond an edge of the separator while forming a plurality of winding turns about the center of the electrode assembly 100, such that the second uncoated portion 112b may be exposed and may be used as an electrode tab in itself. The edge of the separator that the second uncoated portion 112b projects axially beyond may be an opposite edge along the axial direction from the edge of the separator that the first uncoated portion 112a projects axially beyond. Thus, the resulting electrode tabs of opposite polarities may be positioned at axially opposing ends of the wound electrode assembly 100.

That is, the positive electrode plate and the negative electrode plate may each include an uncoated portion 112a, 112b that is not coated with the active material at a long side end in the winding direction. And, the first uncoated portion 112a and the second uncoated portion 112b may be configured to project in opposite directions.

As an example, the first uncoated portion 112a and the second uncoated portion 112b may each include notched tabs in the form of flags that may be formed by forming notches at predetermined intervals in the winding direction. In the jelly-roll-shaped electrode assembly 100, the notched tabs may be bent radially and flattened. The notched tabs may be bent radially inward or outward. The notched tabs may be bent one by one during the process of winding the stack to form the jelly-roll-shaped electrode assembly 100. Alternatively, the notched tabs may be bent all at once after the stack is wound to form the jelly-roll-shaped electrode assembly 100. The notched tabs of the first uncoated portion 112a and the notched tabs of the second uncoated portion 112b, which are bent radially and overlapped in this way, may each form a plane substantially perpendicular to the axial direction at opposite axial ends of the electrode assembly 100.

A positive electrode current collector plate 600 may be bonded to the notched tabs of the first uncoated portion 112a. The positive electrode current collector plate 600 may be manufactured by punching, trimming, piercing, and/or bending a metal sheet. Specifically, the positive electrode current collector plate 600 is made of a conductive metal material and is connected to the first uncoated portion 112a of the electrode assembly 100. When the first uncoated portion 112a comprises the notched tabs that are radially bent and flattened, the space occupied by the first uncoated portion 112a in the axial direction in the battery cell 10 is reduced, which may result in an increase in energy density. Additionally, an increase in the coupling area between the first uncoated portion 112a and the positive electrode current collector plate 600 may lead to improved coupling force and reduced resistance.

This electrode assembly 100 may be accommodated inside the cell housing 200. The cell housing 200 may comprise an opening 210 in a first end of the cell housing 200 in the axial direction. The electrode assembly 100 may be inserted through the opening 210 in the first end of the cell housing 200 such that the electrode assembly 100 is accommodated within the cell housing 200. The electrode assembly 100 may be accommodated in the cell housing 200 so that the first uncoated portion 112a is positioned adjacent to a bottom portion 220 of the cell housing 200.

The cell housing 200 may be a can including a side wall portion 205, an opening 210 provided at the first end of the side wall portion 205 in the axial direction, and a bottom portion 220 connected to a second end of the side wall portion 205 in the axial direction. In other words, the can may include a bottom portion 220 and a side wall portion 205 connected to the bottom portion 220 and extending in the axial direction. The first end of the side wall portion 205 that is not connected to the bottom portion 220 may define an opening 210 of the can.

A terminal 400 may be disposed on the bottom portion 220 of the cell housing 200. A center of the bottom portion 220 may comprise a through hole, and at least a portion of the terminal 400 may extend through the through hole. The terminal 400 may be fixed to the bottom portion 220 with a terminal gasket 500 interposed between the bottom portion 220 and the terminal 400. The terminal 400 may be connected to the first electrode of the electrode assembly 100 and may have a first polarity. The terminal 400 may be in the form of a rivet. The terminal 400 is electrically connected to the first uncoated portion 112a of the first electrode.

The bottom portion 220 and the side wall portion 205 of the cell housing 200 may be manufactured by molding a metal sheet by a deep drawing process, and trimming the front end of the side wall portion 205 with a punch while gripping it with a blank holder. In some aspects, the metal sheet may be a steel sheet plated with nickel. Of course, the material of the cell housing 200 is not limited thereto. For example, the material of the cell housing 200 may be a conductive metal, such as aluminum, steel, stainless steel, or the like, but is not limited thereto.

An insulator 700 may be interposed between the positive electrode current collector plate 600 and the bottom portion 220 of the cell housing 200 to electrically insulate the positive electrode current collector plate 600 and the bottom portion 220. The positive electrode current collector plate 600 and the terminal 400 may be bonded by a method such as resistance welding, ultrasonic welding, or laser welding, so that the terminal 400 may be connected to the first electrode of the electrode assembly 100.

A can lid 300 may be coupled to the side wall portion 205 of the cell housing 200 at the first end of the cell housing 200 in the axial direction. The can lid 300 may cover the opening 210. The can lid 300 may cover the electrode assembly 100. The can lid 300 may be forcibly fitted into the opening 210 such that the can lid 300 may be at least temporarily secured within the opening 210 by a press fit. The can lid 300 may later be more permanently secured to the cell housing 200, such as by welding, as discussed below.

The can lid 300 may be electrically connected to the cell housing 200. In one or more aspects, the side wall portion 205 of the cell housing 200 at the first end of the cell housing 200 in the axial direction and the edge of the can lid 300 may be bonded so that the cell housing 200 and the can lid 300 are electrically connected while the electrode assembly 100 is accommodated inside the cell housing 200.

The bonding may be performed by welding, brazing, or soldering.

The can lid 300 may have a disk shape to cover the opening 210 of the cell housing 200. And, the can lid 300 may be press fit into the opening 210 of the cell housing 200.

The can lid 300 may be coupled to the cell housing 200 using butt welding. In such aspects, the battery cell 10 may have a larger internal capacity than a battery cell 10 having the same external shape but using a beading and crimping method of closure. Therefore, energy density may be increased.

The second uncoated portion 112b of the second electrode of the electrode assembly 100 may be positioned adjacent to and may face the opening 210 of the cell housing 200. In such aspects, the can lid 300 may be connected to the second electrode of the electrode assembly 100. In such aspects, the can lid 300 may have a second polarity, and the cell housing 200 electrically connected to the can lid 300 may also have the second polarity. In some aspects, the bottom of the cell housing 200 and the side wall portion 205 connected thereto may both have the second polarity.

In one or more aspects, the cell housing 200 may have a positive terminal and a negative terminal disposed at the same end of the cell housing 200 in the axial direction. For example, the cell housing 200 may have a positive terminal and a negative terminal at the second end, i.e., the bottom, of the cell housing 200 in the axial direction. Busbars connected to the terminals of both polarities may all be positioned at the same end of the cell housing 200 in the axial direction. In such aspects, the electrical connection structure of a plurality of battery cells may be simplified since both the positive electrode and the negative electrode face the same side of the battery cell in the axial direction. Additionally, since the battery cell 10 according to the present disclosure has a structure in which most of the bottom of the cell housing 200 may be used as a terminal of the second polarity, there is an advantage of securing a sufficient area for welding components for electrical connection.

In one or more aspects, the battery cell 10 may be a cylindrical secondary battery having, for example, a form factor ratio (ratio of diameter to height) greater than approximately 0.4. For example, the diameter of the battery cell 10 may be 40 mm to 50 mm, and the height may be 60 mm to 130 mm. The form factor of the battery cell 10 may be, for example, 46110, 4875, 48110, 4880, or 4680.

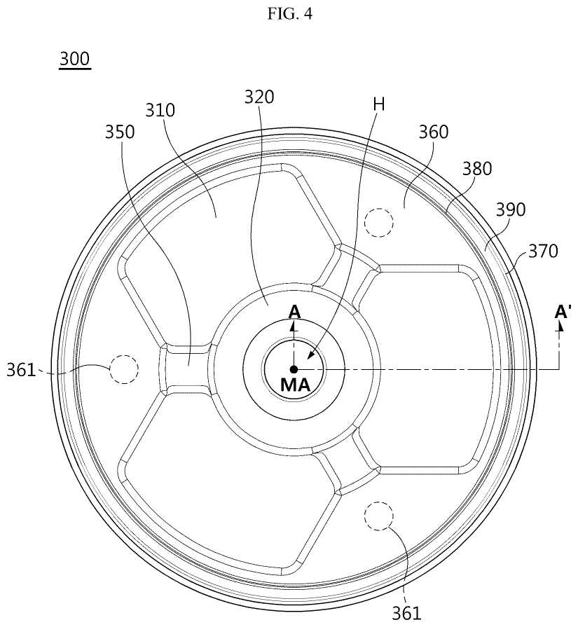

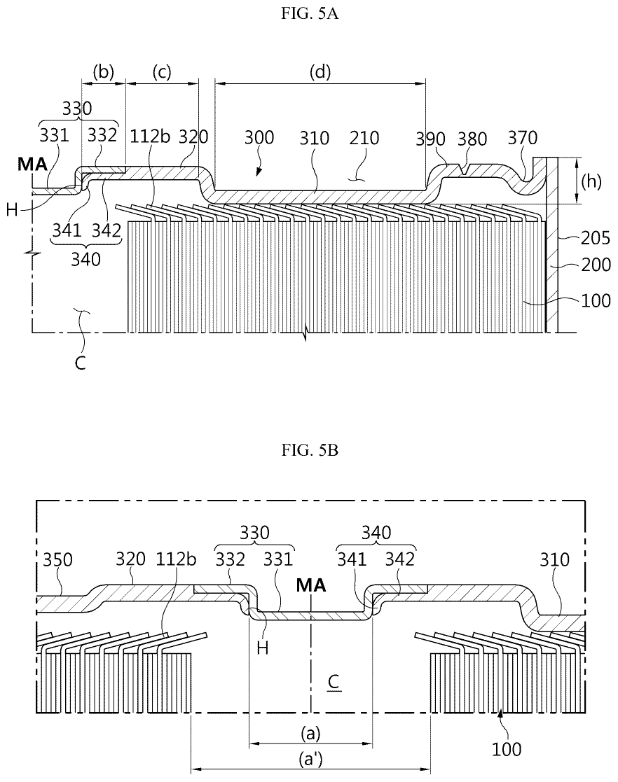

FIG. 4 is a plan view of a can lid 300 of a battery cell 10 according to an aspect of the present disclosure, FIG. 5A is a side cross-sectional view taken along section line A-A′ in FIG. 4, and FIG. 5B is a side cross-sectional view showing, in an enlarged manner, a region around an injection port H of a battery cell 10 according to an aspect of the present disclosure.

Referring to FIGS. 4 and 5, the can lid 300 according to an aspect of the present disclosure may include an edge portion 370. The edge portion 370 may extend along a perimeter of the can lid 300. The edge portion 370 may be configured to be coupled to the cell housing 200. For example, the edge portion 370 may be joined to the side wall portion 205 of the cell housing 200 at the first axial end of the cell housing 200. The can lid 300 may comprise an electrode coupling portion 310. The electrode coupling portion 310 may be coupled to an electrode assembly 100. The electrode coupling portion 310 may be recessed relative to the edge portion 370 of the can lid 300. For example, the electrode coupling portion 310 may extend further into an interior of the cell housing 200 than the edge portion 370 of the can lid 300 when the can lid 300 is joined to the side wall portion 205 of the cell housing 200 In one or more aspects, the can lid 300 may comprise a plurality of electrode coupling portions 310.

The can lid 300 covers an opening 210 of the cell housing 200, and the can lid 300 may be press fit into the opening 210. Thereafter, in a cap bonding step, the edge portion 370 of the can lid 300 may be bonded to a side wall portion 205 of the cell housing 200 such that the can lid 300 is electrically connected to the side wall portion 205 of the cell housing 200 and such that the opening 210 at the first axial end of the cell housing 200 is sealed. The can lid 300 and the cell housing 200 may be bonded by various ways such as welding, brazing, and soldering, which may allow them to be electrically connected and sealed. For example, the can lid 300 and the cell housing 200 may be bonded by laser welding.

The edge portion 370 of the can lid 300 may include a mating surface 372, a curved surface 371a, and an inclined surface 371b. The curved surface 371a may be between the mating surface 372 and the inclined surface 371b. The mating surface 372 may be spaced apart from a central axis of the battery cell 10 in a radial direction a greater distance than the curved surface 371a and the inclined surface 371b. In one or more aspects, the mating surface 372 may be on the perimeter of the can lid 300. The mating surface 372, the curved surface 371a, and the inclined surface 371b may form a U-shaped bent portion 321.

The can lid 300 may further include an injection port H and a flat portion 320.

The injection port H may be configured such that an electrolyte may be injected into the cell housing 200 through the injection port H. The injection port H may be positioned approximately in the center MA of the can lid 300. For example, a central axis of the cell housing 200 may pass through the injection port H.

The flat portion 320 may surround the injection port H. The flat portion 320 may extend from the injection port H in a radial direction and may surround the injection port H in a circumferential direction. The flat portion 320 may have an at least partially flat shape. In some aspects, the flat portion 320 may comprise one or more major surfaces that are substantially normal to the central axis of the cell housing 200.

The edge portion 370 of the can lid 300 may include an edge of the can lid 300 configured to be coupled to the cell housing 200. The edge portion 370 may be coupled to an opening 210 on the first end of the cell housing 200 in a force-fitting (or press fit) manner. The edge portion 370 may be coupled to the cell housing 200 by butt welding after being forcibly fitted into the opening 210 on the first end of the cell housing 200.

In one or more aspects, the edge portion 370 may be at least slightly spaced apart from the electrode assembly 100 along the axial direction, as shown in FIG. 5. For example, the edge portion 370 of the can lid 300 may be spaced apart from the electrode assembly 100 by a separation distance T. The edge portion 370 may have a U-shaped bent portion 321 to enhance weldability during seam welding. The U-shaped bent portion 321 of the edge portion 370 may improve the weldability of the edge portion 370 of the can lid 300. Additionally, the separation distance T between the U-shaped bent portion 321 and the electrode assembly 100 may ensure that the inside of the battery cell 10 is not affected by the welding. If the edge portion 370 is in contact with the electrode assembly 100 without the separation distance T, the electrode assembly 100 may be physically affected. This may cause internal damage to the battery cell 10, such as damage due to welding heat during seam welding. The lower end of the edge portion 370 faces the electrode assembly 100, and the upper end of the electrode assembly 100 and the lower end of the edge portion 370 have a separation distance T to minimize the influence of heat from the welding process on the inside of the battery cell 10. For example, through this separation distance T, welding heat during seam welding may be prevented from being directly conducted to the electrode assembly 100, thereby avoiding thermal damage to the electrode assembly 100. Since the edge portion 370 of the can lid 300 and the electrode assembly 100 are not in physical contact with each other, there is no impact on the electrode assembly 100, particularly the second uncoated portion 112b. This may prevent cracking or kinking in the second uncoated portion 112b.

The outer edge of the can lid 300 in the radial direction may comprise the mating surface 372. The mating surface 372 may extend axially so that the outer circumferential surface thereof contacts the inner circumferential surface of the side wall portion 205 of the cell housing 200. The curved surface 371a is connected to the lower end of the mating surface 372 of the can lid 300, that is, the lower end of the mating surface 372 in the axial direction, and has a downwardly convex cross-sectional shape that extends inward radially toward the central axis of the cell housing 200. The slope of the curved surface 371a gradually decreases as it moves away from the mating surface 372. Since the mating surface 372 extends axially, the slope of the tangent line of the outer circumferential surface of the curved surface 371a may gradually decrease from 90 degrees as it moves away from the mating surface 372. The inclined surface 371b continues from the curved surface 371a. The inclined surface 371b extends upwardly in the axial direction as it progresses inwardly in the radial direction, and the slope thereof may be constant. The U shape at the edge of the can lid 300 is configured such that the can lid 300 may be press fit into the opening 210 at the first end of the cell housing 200.

The curved surface 371a and the inclined surface 371b provide a shape that allows the edge portion 370 of the can lid 300 to be elastically deformed radially inward. Accordingly, when the can lid 300 is pressed into the opening 210, the can lid 300 may be fitted into the opening 210 as the U-shape is compressed and then spread without causing deformation of other parts of the can lid 300. Accordingly, a radial adhesion between the side wall portion 205 of the cell housing 200 and the mating surface 372 may be secured. In other words, the mating surface 372 between the can lid 300 and the cell housing 200 may have a snug fit without being distorted during the process of pressing the can lid 300 into the opening 210 of the cell housing 200.

In this way, the can lid 300 may be pressed into the inner circumferential surface of the side wall portion 205 of the cell housing 200 to reduce the occurrence of a gap between the side wall portion 205 of the cell housing 200 and the edge of the can lid 300. Such pressure insertion of the can lid 300 may result in easier assembly and increased productivity when forming battery cells. The edge of the can lid 300 may be closely butt welded to the inner circumferential surface of the cell housing 200, so that there is no need for tack welding. Additionally, the laser of the butt welding may not be incident into the internal space of the cell housing 200, thereby causing no damage to the electrode assembly 100 during the welding process. Furthermore, the thickness of the weld may not be reduced, which may improve weld strength.

The mating surface 372 may have a length less than or equal to 0.7 mm in the axial direction.

In one or more aspects, the electrode coupling portion 310 of the can lid 300 may be coupled to the electrode assembly 100. In one or more aspects, the electrode coupling portion 310 of the can lid 300 may be directly connected to the electrode assembly 100. The electrode coupling portion 310 may be coupled to the second uncoated portion 112b of the electrode assembly 100 by welding. In one or more aspects, the bottom surface (the surface facing the electrode assembly 100) of the electrode coupling portion 310 may be coupled to the electrode assembly 100 in a face-to-face manner. The second uncoated portion 112b of the second electrode is directly connected to the electrode coupling portion 310 of the can lid 300. The bottom surface of the electrode coupling portion 310 may be coupled to the second uncoated portion 112b of the electrode assembly 100. That is, the second uncoated portion 112b may have the foil tabs, and the foil tabs along the upper axial end of the electrode assembly 100 maybe bent in the radial direction (e.g., radially inwardly), such that the upwardly oriented surfaces of the tabs after bending may come into contact with and be welded to the electrode connecting portions of the can lid 300 (e.g., the bottom surface of the electrode coupling portion 310), similar to the manner disclosed in the incorporated '950 Publication.

The electrode coupling portion 310 may be between the flat portion 320 and the edge portion 370 of the can lid 300. For example, the flat portion 320, the electrode coupling portion 310, and the edge portion 370 of the can lid 300 may be sequentially disposed along the radial direction. The can lid 300 may comprise a plurality of electrode coupling portions 310, and each of electrode coupling portion 310 of the plurality of electrode coupling portions 310 may be spaced apart from each other. For example, the plurality of electrode coupling portions 310 may be spaced apart from each other in the circumferential direction.

Each of the plurality of electrode coupling portions 310 may be recessed downwardly in the axial direction relative to the flat portion 320 and the edge portion 370 of the can lid 300. Specifically, the electrode coupling portions 310 may be recessed toward the electrode assembly 100. The bottom surface of each of the plurality of the electrode coupling portions 310 may be closer to the electrode assembly 100 than the remainder of the bottom surface of the can lid 300. In such aspects, when the electrode coupling portions 310 are coupled to the electrode assembly 100, the remaining portion of the can lid 300 may be spaced at least slightly apart from the electrode assembly 100.

The can lid 300 according to an aspect of the present disclosure may comprise a plurality of electrode coupling portions 310 that are spaced apart from each other and recessed such that the flat portions 320 of each of the plurality of electrode coupling portions 310 are in substantially the same plane. This may result in a relatively flat surface that may be stably and evenly joined to the electrode assembly 100. This may improve the welding quality between the can lid 300 and the electrode assembly 100 according to an aspect of the present disclosure.

The electrode coupling portion 310 may comprise a bottom surface that extends in the radial direction and is normal to the central axis of the cell housing 200. The height of the bottom surface of the electrode coupling portion 310 may be less than the height of the lower end of the curved surface 371a. For example, the electrode coupling portion 310 may protrude further axially into the cell housing 200 than the curved surface 371a. In one or more aspects, the lower end of the curved surface 371a may be spaced apart from the electrode assembly 100 inside the cell housing 200 by a separation distance T in the axial direction, while the bottom surface of the electrode coupling portion 310 may be in close contact with the electrode assembly 100. Accordingly, the coupling process between the electrode coupling portion 310 and the electrode assembly 100 may be smoothly performed.

Meanwhile, since the can lid 300 according to aspects of the present disclosure may be coupled to the cell housing 200 to cover the opening 210 of the cell housing 200 and simultaneously may be electrically connected to the electrode assembly 100, a separate negative electrode current collector plate need not be included in the battery cell 10. In one or more aspects, the can lid 300 according to the present disclosure may be an integrated can lid 300 capable of performing the functions of a current collector plate and the can lid 300 simultaneously. In such aspects, a current collector plate is not interposed between the can lid 300 and the electrode assembly 100. In some aspects, the battery cell 10 may be free from a negative electrode current collector plate.

The can lid 300 may be electrically connected to the cell housing 200. For example, the can lid 300 may be electrically connected to the cell housing 200 through the coupling portion of the mating surface 372 of the edge portion 370 of the can lid 300 and the inner circumferential surface of the side wall portion 205 of the cell housing 200. The can lid 300 may be laser welded to the cell housing 200, and the electrode coupling portion 310 of the can lid 300 may be laser welded to the second uncoated portion 112b of the electrode assembly 100. Then, the can lid 300 may serve as a negative electrode current collector plate.

According to aspects of the present disclosure, a bonding part between the can lid 300 and the cell housing 200 may be simplified, and there is no need to use a current collector plate when electrically connecting the electrode assembly 100 to the can lid 300. This may reduce the number of parts and assembly man-hours. This may also use less internal volume within the cell housing 200, thereby increasing energy density of the battery cell 10.

The electrode coupling portion 310 may extend toward the flat portion 320 and the edge portion 370 of the can lid 300. Specifically, the electrode coupling portion 310 may extend radially inwardly toward the flat portion 320, and the electrode coupling portion 310 may extend radially outwardly toward the edge portion 370. In this case, the length (d) of the electrode coupling portion 310 in the radial direction, which can affect a lid foil tab welding (LFW) length between the electrode coupling portion 310 and the foil tab, may have a length such that the internal resistance of the battery cell 10 may be reduced.

The can lid 300 may comprise a plurality of electrode coupling portions 310, which may be spaced apart circumferentially with respect to the center of the can lid 300.

In the present aspect, the can lid 300 may comprise three electrode coupling portions 310. When the can lid 300 comprises three electrode coupling portions 310, the plurality of electrode coupling portions 310 may easily form one plane, and thus a stable connection with the electrode assembly 100 may be secured more easily. However, it should be understood that the can lid 300 may comprise any suitable number of electrode coupling portions 310. For example, the can lid 300 may comprise 1, 2, 3, 4, 5, 6, 7, 8, 9, 10, or more electrode coupling portions 310.

The electrode coupling portion 310 may be formed by any suitable manufacturing method, such as a plastic processing method, so that a predetermined part of the can lid 300 in the form of a metal sheet is recessed axially downward. The bonding part of the electrode coupling portion 310 and the electrode assembly 100 may each extend in the radial direction.

The inner circumferential surface of the side wall portion 205 of the cell housing 200 and the mating surface 372 of the can lid 300 may be pressed against each other to be bonded.

The can lid 300 according to an aspect of the present disclosure may further include at least one bridge 350. In some aspects, the can lid 300 may comprise a plurality of bridges 350. For example, the can lid 300 may comprise 1, 2, 3, 4, 5, 6, 7, 8, 9, 10, or more bridges 350. In some aspects, the can lid 300 may comprise three bridges 350. Each bridge 350 may extend radially from the flat portion 320. In one or more aspects, a bridge 350 may separate two adjacent electrode coupling portions 310 in the circumferential direction. The bridge 350 may extend from the flat portion 320 toward the edge portion 370. Alternatively, the bridge 350 may extend from the flat portion 320 toward the picking portion 360 to be described later.

The plurality of electrode coupling portions 310 may be partitioned and spaced apart by the plurality of bridges 350. Additionally, the bridge 350 may improve the rigidity of the can lid 300.

In one or more aspects, the upper surface of the bridge 350 may be at a height greater than the upper surface of the electrode coupling portion 310, but less than the upper surface of the flat portion 320. When the bridge 350 is formed in this way, the rigidity of the can lid 300 may be further improved.

The plurality of electrode coupling portions 310 may be formed and disposed symmetrically relative to the center MA of the can lid 300. Each of the electrode coupling portions 310 may be formed in the same shape and may be disposed to form an equiangular angle with respect to the can lid 300. In this way, when the plurality of electrode coupling portions 310 are formed and disposed symmetrically, a stable connection between the can lid 300 and the electrode assembly 100 may be secured, and the electrical stability of the battery cell 10 may also be improved.

The can lid 300 according to an aspect of the present disclosure may further include a plug coupling portion 340. The plug coupling portion 340 may surround the injection port H in a circumferential direction. The injection port H may be in the center of the plug coupling portion 340. The plug coupling portion 340 may be shaped such that a plug 330 may be inserted into and seated on the plug coupling portion 340. The plug 330 may be configured to seal the injection port H when inserted into and seated on the plug coupling portion 340. The plug 330 may be formed by deep drawing a thin metal sheet of 0.3 mm. If the thin metal sheet is too thin, molding is difficult and rigidity is insufficient. The total height of the plug 330 may be 1.5 mm to 1.7 mm.

The plug coupling portion 340 may have an insertion portion 341 and a seating portion 342. A plug 330 may be inserted into the insertion portion 341. The insertion portion 341 of the plug coupling portion 340 may extend axially toward an interior of the cell housing 200. The plug 330 may have a protrusion 331 shaped to be inserted into the insertion portion 341. The protrusion 331 of the plug 330 may be coupled to the insertion portion 341 of the plug coupling portion 340 in a force-fitting manner. The insertion portion 341 of the plug coupling portion 340 may be an outer edge of the injection port H, and when the protrusion 331 of the plug 330 is inserted into the insertion portion 341 of the plug coupling portion 340, the injection port H may be sealed.

The plug 330 may be seated on the seating portion 342. The plug 330 may have an extension portion 332 configured to contact the seating portion 342 of the plug coupling portion 340. The extension portion 332 of the plug 330 may extend in the radial direction from the insertion portion 341. The seating portion 342 of the plug coupling portion 340 may extend radially from the insertion portion 341 of the plug coupling portion 340. The seating portion 342 of the plug coupling portion 340 may be stepped so that the extension portion 332 of the plug 330 may be seated on the seating portion 342. The extension portion 332 of the plug 330 and the seating portion 342 of the plug coupling portion 340 of the can lid 300 may be coupled to each other by welding.

As described above, when the can lid 300 includes the plug coupling portion 340, the coupling between the plug 330 and the can lid 300 may be improved, and the injection port H may be effectively sealed.

In one or more aspects, the insertion portion 341 protrudes into an interior of the cell housing 200 in an axial direction less than the electrode coupling portion 310 of the can lid 300. Since the insertion portion 341 is slightly higher than the electrode coupling portion 310, it may be spaced apart from the electrode assembly 100. This may prevent damage to the electrode assembly 100 by preventing the plug welding heat from being transferred to the separator of the electrode assembly 100.

Referring to FIG. 5A, length (b) of the seating portion 342 is a radial distance from the injection port H to the flat portion 320 of the can lid 300. As the length (b) of the seating portion 342 from the injection port H to the end of the flat portion 320 increases, the weldability of the extension portion 332 of the plug 330 and the seating portion 342 may be improved. The length (b) may be designed to prevent welding defects of the plug 330 due to the heat of vaporization of the electrolyte. In one or more aspects, the length (b) may be from 1 mm to 3 mm. For example, the length (b) may be 2 mm. In such aspects, the outer diameter of the seating portion 342 is 4 mm larger than the diameter of the injection port H. The seating portion 342 may be formed by any suitable method, for example, by a forging method.

Still referring to FIG. 5A, length (c) is a length of the flat portion 320 extending radially from the plug coupling portion 340 to the electrode coupling portion 310. The length (c) of the flat portion 320 may be an appropriate length to secure a flat surface for the electrode coupling portion 310. For example, the length (c) may be 3 mm or more. If the length (c) is less than 3 mm, it may be difficult to mold the flat portion 320.

The injection port H may have a shape in which a pipe portion is formed through piercing and burring, or may be a hole through which the insertion portion 341 is pierced.

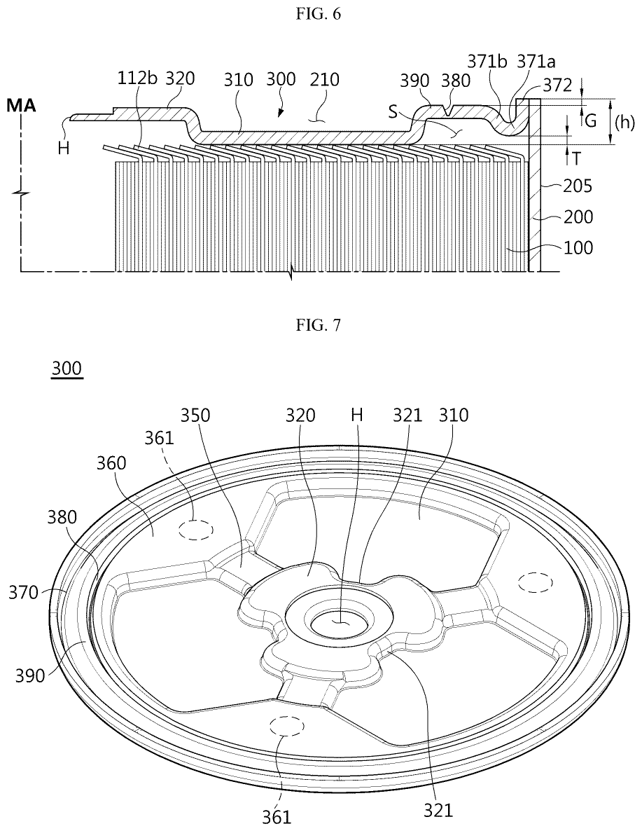

FIG. 6 depicts a modified can lid 300 relative to the aspect of the can lid 300 depicted in FIG. 5. Referring to FIG. 6, the injection port H is formed by piercing.

Referring to FIG. 5B, the can lid 300 may be configured such that the center of the winding center hole C and the center of the injection port H coincide with the central axis MA of the cell housing 200. Accordingly, the can lid 300 and the electrode assembly 100 may be arranged in a concentric structure with each other.

When the can lid 300 is configured as described above, uniform injection of the electrolyte can be achieved during electrolyte filling through the injection port H. In addition, when a welding rod is inserted through the injection port H into the winding center hole C, interference with the winding center hole C can be prevented, and such insertion can be easily and precisely carried out.

In FIGS. 5 and 6, the injection port H may be a hole through which an electrolyte may be injected and through which a welding rod may be passed. For example, a current collector plate (e.g., a positive electrode current collector plate 600) and a rivet-shaped terminal 400 may be disposed on an opposite axial end of the battery cell 10 from the injection port H, and a welding rod may be inserted through the injection port H into the winding center hole C of the electrode assembly 100 to weld the current collector plate and the terminal 400. Accordingly, the diameter (a) of the injection port H may be larger than the diameter of the welding rod in order to avoid interference of the welding rod. Additionally, the diameter (a) of the injection port H may be smaller than the size (a′) of the winding center hole C for stable injection of the electrolyte. If the diameter (a) of the injection port H is larger than the size (a′) of the winding center hole C, the separator in the winding center hole C of the electrode assembly 100 may loosen or come off when the electrolyte is injected at high pressure. The diameter (a) of the injection port H taking this into account may be 5 mm to 5.5 mm in one or more aspects of the present disclosure.

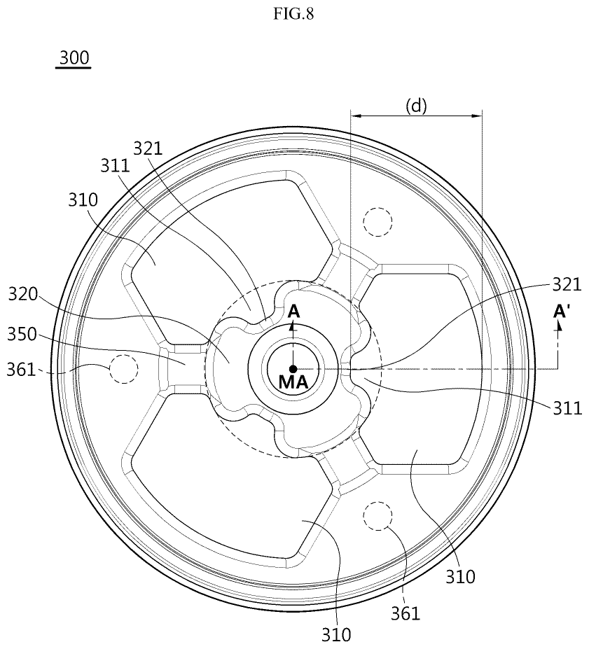

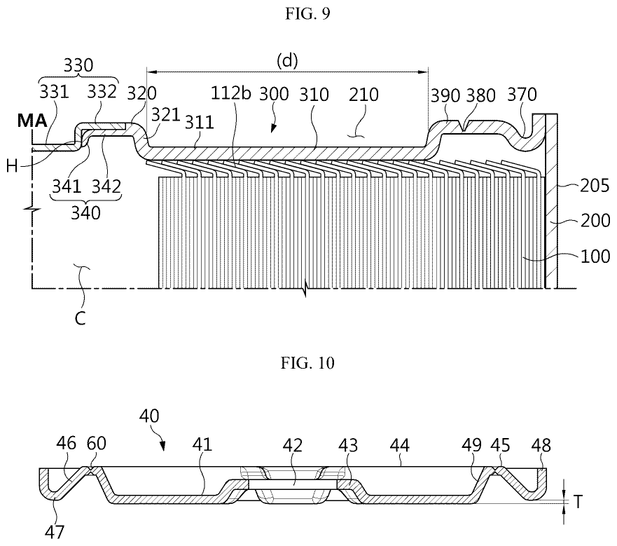

FIG. 7 is a perspective view of a can lid 300 according to another aspect of the present disclosure, FIG. 8 is a plan view showing a can lid 300 according to another aspect of the present disclosure, and FIG. 9 is a side cross-sectional view taken along section line A-A′ in FIG. 8.

Referring to FIGS. 7 to 9, a can lid 300 according to another aspect of the present disclosure may have a bent portion 321 and an electrode coupling portion 310, and the electrode coupling portion 310 may comprise an extended portion 311.

The bent portion 321 may be an indentation in the perimeter of the flat portion 320 in the axial direction. For example, when the flat portion 320 of the can lid 300 has a substantially circular shape, the bent portion 321 may be an indentation from the substantially circular perimeter of the flat portion 320 in the axial direction toward the injection port H. The can lid 300 may comprise one or more bent portions 321. In some aspects, the can lid 300 may comprise the same number of bent portion 321 and electrode coupling portions 310. The extended portion 311 may extend from the electrode coupling portion 310 toward the bent portion 321 in the radial direction. The extended portion 311 may occupy at least a portion of the indentation in the flat portion 320 formed by the bent portion 321. The extended portion 311 may further extend toward the injection port H as much as the bent portion 321 is recessed. For example, a radial edge of the extended portion 311 facing the bent portion 321 may have substantially the same shape as a radial edge of the bent portion 321 facing the extended 311 portion. In one or more aspects the bent portion 321 may be directly connected to the extended 311 portion.

In such aspects, when the flat portion 320 and the electrode coupling portion 310 each have a bent portion 321 and an extended portion 311, the length (d), which is the length of the electrode coupling portion 310 in the radial direction and affects the welding length between the electrode coupling portion 310 and the electrode assembly 100, may be further increased. This may reduce the internal resistance of the battery cell 10. For example, when the can lid 300 does not have a bent portion 321 and an extended portion 311, the length (d) may be about 9 mm, and when the can lid 300 has a bent portion 321 and an extended portion 311, the length (d) may be longer, about 12 mm.

In such aspects, the length (c) in the remainder of the flat portion 320, excluding the bent portion 321, may be easily secured, and the length (a) and/or the length (b) may be easily secured. This may improve the rigidity of the can lid 300. Additionally, as the internal resistance of the battery cell 10 may be reduced, the width (in the circumferential direction) of the electrode coupling portion 310 may be reduced, thereby easily securing the picking portion 360 to be described later.

When the length (a), length (b), length (c), and length (d) are designed as described above, various dimensions of the can lid 300, including the welding flatness and welding length of the can lid 300, and the diameter (a) of the injection port H, may be optimized.

Referring to FIGS. 3 to 9, the can lid 300 according to aspects of the present disclosure may further include a vent notch portion 380.

The vent notch portion 380 is included on a surface of the can lid 300 facing away from the electrode assembly 100. For example, the vent notch portion 380 may be on an exterior surface of the can lid 300 that faces away from the interior of the cell housing 200. In one or more aspects, the vent notch portion 380 may be formed on the upper part of the can lid 300. The vent notch portion 380 may be formed on the upper surface of the can lid 300.

The vent notch portion 380 may be configured to be ruptured by an increase in the internal pressure of the battery cell 10 above a maximum internal pressure. The vent notch portion 380 may be configured to release a high-temperature venting gas when a thermal event occurs in the battery cell 10, and accordingly, the venting gas may be discharged from the battery cell 10 to an area outside the battery cell 10 through the ruptured vent notch portion 380. The vent notch portion 380 may comprise a notch extending along the circumferential direction on the inner side of the edge portion 370 of the can lid 300.

The rupture pressure of the cell housing 200 may be controlled by controlling the depth and width of the vent notch portion 380. For example, the vent notch portion 380 may be configured to be ruptured when the pressure inside the cell housing 200 is in the range of 15 kgf/cm² to 35 kgf/cm². The vent notch portion 380 may be formed by partially reducing the thickness of the can lid 300 to form a notch or indentation. The vent notch portion 380 may have a thickness gradient. The thickness gradient means that when the cross-section of the vent notch portion 380 is checked, it is inclined at a certain angle based on a predetermined horizontal plane. This vent notch portion 380 is ruptured when the pressure inside the cell housing 200 rises above a predetermined pressure, so that at least a portion of the internal gas is discharged to an area outside the battery cell 10.

In one or more aspects, the thickness of the can lid 300 may be from 0.4 mm to 0.8 mm. For example, the thickness of the can lid 300 may be 0.6 mm.

In one or more aspects, the battery cell 10 may be a 4680 battery cell. For a 4680 battery cell, when the thickness of the side wall portion 205 is considered and the one-side force-fitting amount is designed to be about 110 μm, the diameter of the can lid 300 may be 45.2 mm.

In a cross-section of the can lid 300 in the axial direction, the vent notch portion 380 may have a V-shaped or U-shaped cross-section.

In an upper surface of the can lid 300, the vent notch portion 380 may have a closed loop shape. In such aspects, the vent notch portion 380 may extend continuously on the upper surface of the can lid 300 in the circumferential direction around at least a portion of the can lid 300.

The vent notch portion 380 may be ruptured when the pressure inside the cell housing 200 exceeds a threshold. The vent notch portion 380 may form a continuous or discontinuous circular pattern, a linear pattern, or other patterns on the surface of the can lid 300. For example, the vent notch portion 380 may be formed in a roughly circular ring shape having a certain width. This circular ring-shaped vent notch portion 380 may have the same center as the center of the can lid 300.

The vent notch portion 380 may be formed by (unidirectional) notching only on one surface of the can lid 300. For example, the surface of the can lid 300 facing the interior of the cell housing 200 may not be notched and the surface of the can lid 300 facing away from the interior of the cell housing 200 may be notched.

When the vent notch portion 380 is formed on the can lid 300, the venting gas may be easily discharged from the battery cell 10. Since the vent notch portion 380 is provided on the can lid 300 and does not occupy a separate space within the battery cell 10, the energy density of the battery cell 10 may be improved.

The can lid 300 may be a metal sheet including a plating layer on both surfaces. The can lid 300 comprises a first plating layer at the first surface, and the can lid 300 comprises a second plating layer at the second surface. For example, the can lid 300 may be nickel-plated steel (NPS).

In aspects where the can lid 300 comprises NPS, peeling of nickel plating may occur during the notching process. Therefore, when the vent notch portion 380 is formed only on the upper part of the can lid 300, there is no concern about foreign substances being introduced to the electrode assembly 100.

If the steel below the nickel plating is exposed through notching, there may be a problem of corrosion such as fluoride being generated when in contact with the electrolyte. In aspects where the vent notch portion 380 is formed on the side of the can lid 300 that does not face the electrode assembly 100 as in aspects of the present disclosure, there is no concern about contact of the vent notch portion 380 with the electrolyte, resulting in no problem of corrosion.

If the notch is on the side of the can lid 300 that faces the electrode assembly 100, the notched portion may be damaged by expansion and contraction of the electrode assembly 100 occurring during the activation and charging and discharging processes. If the vent notch portion 380 is on the side of the can lid 300 that does not face the electrode assembly 100, as in aspects of the present disclosure, the problem of damage to the vent notch portion 380 due to expansion and contraction of the electrode assembly 100 is fundamentally prevented.

By forming the vent notch portion 380 in the upper surface of the can lid 300 in this way, corrosion of the can lid 300 or contact with the electrode assembly 100 may be avoided. This may result in normal operation of the battery cell 10 while maintaining the shape of the vent notch portion 380.

The vent notch portion 380 may be further from the injection port H than the electrode coupling portion 310 in the radial direction. For example, the vent notch portion 380 may be between the electrode coupling portion 310 and the edge portion 370 of the can lid 300.

In one or more aspects, the electrode coupling portion 310 is recessed in the axial direction relative to the flat portion 320 and the edge portion 370 of the can lid 300. In such aspects, the vent notch portion 380 may be in a part of the can lid 300 that is not recessed to the same extent or to a greater extent than the electrode coupling portion 310. In such aspects, the portion of the can lid 300 comprising the vent notch portion 380 is spaced apart from the electrode assembly 100 in the axial direction. Referring to FIG. 6, a space S is provided between the vent notch portion 380 and the electrode assembly 100, so that gas may gather in this space S. When the gas pressure in this part exceeds a predetermined value, the vent notch portion 380 may be ruptured and the gas may be discharged to an area outside of the battery cell 10. If the vent notch portion 380 is in a part of the can lid 300 that is recessed toward the electrode assembly 100, it will be difficult to gather gas between the electrode assembly 100 and the vent notch portion 380 of the can lid 300 as described above, and it will not be easy to rupture the vent notch portion 380.

In one or more aspects, the can lid 300 may further include a support surface 390 comprising a flat surface between the inclined surface 371b of the edge portion 370 and the electrode coupling portion 310. The vent notch portion 380 may be formed on this support surface 390. The electrode coupling portion 310 is connected to an inner side of the support surface 390 in the radial direction, and the electrode coupling portion 310 may be recessed toward an interior of the cell housing 200 relative to the support surface 390.

The support surface 390 may extend horizontally in the radial direction. The support surface 390 may be further inward toward a central axis of the cell housing 200 in the radial direction than the curved surface 371a of the can lid 300. The support surface 390 is connected to an inner end of the inclined surface 371b in the radial direction, and the support surface 390 may extend horizontally toward the central axis of the cell housing 200 in the radial direction from the connection part. The support surface 390 comprises a flat surface between the inclined surface 371b and the electrode coupling portion 310. In one or more aspects, the support surface 390 may have a flat ring shape.

The vent notch portion 380 may not be deformed by the force applied to the can lid 300 when the can lid 300 is pressed into the cell housing 200. The vent notch portion 380 may be broken when the internal pressure of the battery cell 10 increases sharply due to a short circuit or the like occurring inside the cell housing 200, so that the electrode coupling portion 310 of the can lid 300 and the mating surface 372 of the can lid 300 may be separated from each other. Accordingly, the electrode coupling portion 310 connected to the electrode assembly 100 and the cell housing 200 are electrically disconnected, and the internal space of the cell housing 200 is opened to the environment outside the battery cell 10, which discharges the gas causing the increase in internal pressure.

An upper surface of the support surface 390 in the axial direction may be disposed lower in the axial direction than an upper end of the mating surface 372. In such aspects, there is a gap G between the upper surface of the mating surface 372 and the upper surface of the support surface 390. Accordingly, when the battery cell 10 is placed on a surface, the vent notch portion 380 may not directly touch the surface, thereby protecting the vent notch portion 380 from unintended damage or rupture.

The can lid 300 (integrated type) according to aspects of the present disclosure may have a notch thickness of the vent notch portion 380 similar to that of a conventional can lid (separate type), which has an advantage of improving the formability of the vent notch portion 380 and having a lower vent pressure. A lower vent pressure may improve the safety of the battery cell 10.

The total height h of the can lid 300 may be 1.0 mm to 3 mm. In such aspects, most of the internal space of the cell housing 200 may be filled with the electrode assembly 100.

Referring to FIG. 4 or 8 again, the can lid 300 according to aspects of the present disclosure may further include a picking portion 360.

The picking portion 360 may be between two adjacent electrode coupling portion 310s and the edge portion 370. A picking area 361 may be formed in the picking portion 360. The picking area 361 may be configured to be gripped by a picking device. The diameter of the picking area 361 may be from 2 mm to 6 mm. For example, the diameter of the picking area 361 may be about 4 mm.

When the can lid 300 according to aspects of the present disclosure has a picking portion 360, the picking device may not be in contact with the electrode coupling portion 310. This may prevent foreign substances or the like from flowing into the electrode coupling portion 310 from the picking device, and the can lid 300 may be stably gripped and transferred in the process of assembling the battery cell 10.

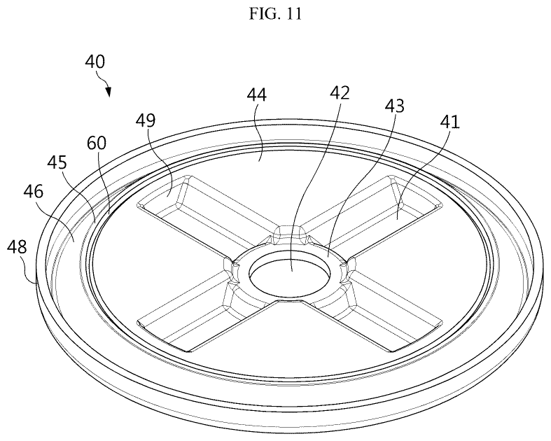

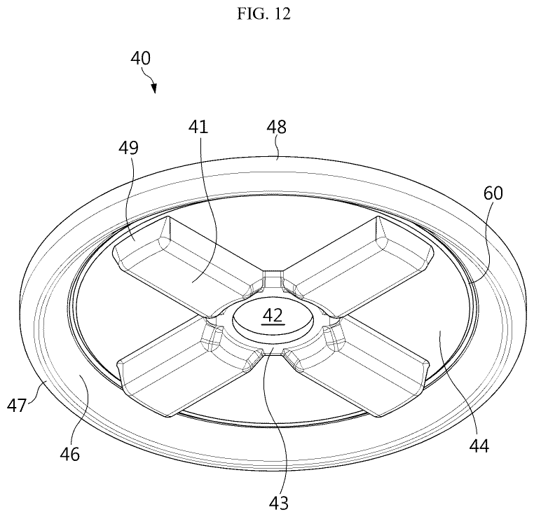

FIG. 10 is a cross-sectional view showing a can lid 40 according to still another aspect of the present disclosure. FIG. 11 is an upper perspective view of the can lid 40 shown in FIG. 10. FIG. 12 is a lower perspective view of the can lid 40 shown in FIG. 10.

In FIGS. 10 to 12, the edge of the can lid 40 may be bonded to the inner circumferential surface of the cell housing 200 by seam welding.

For example, the welding may be performed by a laser irradiated axially downwardly.

The can lid 40 may have a disk shape to cover the opening 210 of the cell housing 200.

The can lid 40 may include a mating surface 48, a curved surface 47, and a first inclined surface 46. The mating surface 48, the curved surface 47, and the inclined surface 46 may be arranged in that order in the radial direction from an outer side of the can lid 40 toward a center of the can lid 40. The mating surface 48, the curved surface 47, and the first inclined surface 46 may form a U-shaped bent portion 321.

The mating surface 48 may be on the outer edge of the can lid 40 in the radial direction, and the mating surface 48 may extend axially so that the outer circumferential surface thereof may contact the inner circumferential surface of the cell housing 200. The curved surface 47 is connected to the lower end of the mating surface 48 of the can lid 40. For example, the lower end of the mating surface 48 in the axial direction may be connected to the curved surface 47. The curved surface 47 may have a downwardly convex cross-sectional shape. The curved surface 47 may extend from the mating surface 48 toward an interior of the cell housing 200 in the axial direction, and toward a center of the can lid 40 in the radial direction. The slope of the curved surface 47 gradually reduces as it moves away from the mating surface 48. In aspects where the mating surface 48 extends axially at 90 degrees, the slope of a line tangent to the outer circumferential surface of the curved surface 47 may gradually decrease from 90 degrees as the tangent line moves away from the mating surface 48.

The first inclined surface 46 extends from the curved surface 47. The first inclined surface 46 extends upwardly away from the interior of the cell housing 200 in the axial direction as it progresses inwardly toward a center of the can lid 40 in the radial direction. In one or more aspects, a slope of the first inclined surface 46 may be constant.

The can lid 40 having a U-shaped bent portion 321 may be suitable for being press fit into the opening 210 of the cell housing 200. The curved surface 47 and the first inclined surface 46 provide a cross-sectional shape that allows the can lid 40 to be elastically deformed in the radial direction. Accordingly, when the can lid 40 is pressed into the opening 210, the can lid 40 may be fitted into the opening 210 as the U-shaped bent portion 321 is compressed and then spread without causing deformation of other parts of the can lid 40. Accordingly, a radial adhesion between the side wall portion 205 of the cell housing 200 and the mating surface 48 may be secured. In other words, the mating surface 48 between the can lid 40 and the cell housing 200 may firmly contact the cell housing 200, without kinking, during the process of pressing the can lid 40 into the opening 210 of the cell housing 200.

Therefore, the inner circumferential surface of the cell housing 200 and the edge of the can lid 40 may be bonded in a state in which the gap between the cell housing 200 and the can lid 40 is reduced or not substantially present. In this way, the gap due to tolerance may be narrowed when the side wall portion 205 of the cell housing 200 and the can lid 40 are bonded.

The can lid 40 may comprise a vent notch portion 60.

The can lid 40 may be directly bonded to the second uncoated portion 112b of the electrode assembly 100. For example, the can lid 40 may be laser welded to the second uncoated portion 112b of the electrode assembly 100. The can lid 40 may further include a support surface 45 and an electrode coupling portion 41 sequentially.

A support surface 45 may extend horizontally in the radial direction. The support surface 45 may extend from the curved surface 47 in the radial direction toward a center of the can lid 40. The support surface 45 may be connected to an inner end of the first inclined surface 46 in the radial direction, and the support surface 47 may extend horizontally from the first inclined surface 46 toward the center of the can lid 40 in the radial direction. The support surface 45 provides a flat surface between the first inclined surface 46 and the electrode coupling portion 41. In such aspects, the surface of the support surface 45 may have a flat annular or ring shape. In one or more aspects, when the battery cell 10 is oriented so that the can lid 40 is placed on a surface, the support surface 45 may serve as the foot of the battery cell 10 and may contact the surface upon which the battery cell 10 is positioned.

An electrode coupling portion 41 may extend horizontally in the radial direction. The electrode coupling portion 41 may be positioned further inwardly toward a center of the can lid 40 in the radial direction than the support surface 45. The electrode coupling portion 41 may be connected to an inner side of the support surface 45 in the radial direction. The electrode coupling portion 41 may be recessed into the cell housing 200 in the axial direction. The electrode coupling portion 41 may be formed by plastic processing so that a predetermined part of the can lid 40 in the form of a metal sheet is recessed inward in the axial direction.

When the can lid 40 is pressed into the cell housing 200, the can lid 40 may be pressed into a position where the bottom surface (axial inner surface) of the electrode coupling portion 41 is in close contact with the second uncoated portion 112b of the electrode assembly 100 inside the cell housing 200. The electrode coupling portion 41 and the second uncoated portion 112b may be bonded by welding. The welding may be performed by irradiating an axially upper surface of the electrode coupling portion 41 with a laser. The laser may be moved in a scanning manner along the radial direction to form a welded portion that extends radially.

In this way, the can lid 40 functions as a cover that closes the opening 210 of the cell housing 200, while also functioning as a negative electrode current collector plate. In such aspects, a negative electrode current collector plate is not interposed between the can lid 40 and the electrode assembly 100.

The bond of the electrode coupling portion 41 and the second uncoated portion 112b may extend in the radial direction. The can lid 40 may comprise a plurality of electrode coupling portions 41. The plurality of electrode coupling portions may be spaced apart from the center of the can lid 40 in the radial direction. For example, in the present aspect illustrated in FIGS. 11-12, the can lid 40 may comprise four electrode coupling portions 41, where at least a pair of the electrode coupling portions 41 opposite each other with respect to the center of the can lid 40 may be diametrically aligned along a straight line.

In such aspects, a plurality of welded portions may extend radially and be disposed at equal intervals along the circumferential direction. The plurality of welded portions extend radially, and thus, the electrode coupling portion 41 may be connected to the second uncoated portion 112b from the outer circumferential side to the core side of the electrode assembly 100. This welding line enlarges the current path, and thus greatly reduces the internal resistance of the second electrode.

When a plurality of electrode coupling portions 41 are configured in this manner, an outer surface 44 may protrude further upwardly than the electrode coupling portions 41 in the axial direction between two adjacent electrode coupling portions 41 in the circumferential direction. The outer surface 44 may be connected to the inner side of the support surface 45 in the radial direction.

When the above-described can lid 40 is used, the bonding part between the can lid 40 and the cell housing 200 is simple, and there is no need to use a current collector plate when electrically connecting the second uncoated portion 112b of the second electrode of the electrode assembly 100 to the cell housing 200. This may reduce the number of parts and assembly man-hours needed to produce the battery cell 10. This may also increase the internal volume of the battery cell 10 available for the electrode assembly 100, thereby increasing energy density of the battery cell 10.

The electrode coupling portions 41 may be in contact with the electrode assembly 100. The lower surface of the U-shaped bent portion 321 may be spaced apart from the electrode assembly 100 by a separation distance T. In such aspects, a gap between a lower surface of the U-shaped bent portion 321 and the lower surface of the electrode coupling portions in the axial direction may have the separation distance T. Accordingly, welding heat during seam welding may be prevented from being directly conducted to the electrode assembly 100 from the U-shaped bent portion 321 of the can lid 40, thereby avoiding thermal damage to the electrode assembly 100. And, since the U-shaped bent portion 321 and the electrode assembly 100 are not in physical contact with each other, there is no impact on the electrode assembly 100, particularly the second uncoated portion 112b, which may prevent cracking or kinking in the second uncoated portion 112b.

In one or more aspects, the vent notch portion 60 may be further outward in the radial direction from the center of the can lid 40 than the electrode coupling portions 41. For example, the vent notch portion 60 may be on the support surface 45. The vent notch portion 60 may be a thin wall portion in which both (i.e., upper and lower) surfaces of the support surface 45 are notched. The vent notch portion 60 may be configured so it is not deformed by the force applied when the can lid 40 is pressed into the cell housing 200. The vent notch portion 60 may be configured such that it is broken when the internal pressure of the battery cell 10 increases sharply due to a short circuit or the like occurring inside the cell housing 200. When the vent notch portion 60 ruptures the electrode coupling portions 41 of the can lid 40 and the mating surface 48 of the can lid 40 may be separated from each other. Accordingly, the electrode coupling portions 41 connected to the second uncoated portion 112b of the second electrode of the electrode assembly 100 and the cell housing 200 are electrically disconnected, and the internal space of the cell housing 200 is opened to an area outside the battery cell 10. This may allow gas causing the increase in the internal pressure of the battery cell 10 to be discharged from the battery cell 10.

The can lid 40 may comprise an injection port 42. For example, the injection port 42 may be in the center of the electrode coupling portions 41. When the opening 210 of the cell housing 200 is covered by the can lid 40, the injection port 42 may be aligned with the core of the electrode assembly 100 accommodated in the cell housing 200.

The injection port 42 may be an opening in the can lid 40. The injection port 42 may extend through the protrusion 43 that protrudes slightly upward in the axial direction from the electrode coupling portion 41 of the can lid 40. The height of the protrusion 43 may be less than the height of the support surface 45 in the axial direction. The protrusion 43 is connected to the radially inward edge of the electrode coupling portions 41 and has a shape that extends axially upward in the radially inward direction. The injection port 42 may be covered with a stopper. The stopper may be a ball, a plug, or other structures. The radially outer edge part of the stopper may be sealed to the radially inner edge part of the injection port 42. For example, the outer edge part of the stopper and the inner edge part of the injection port 42 may be sealed by seam welding or other various sealing methods known in the art.

A second inclined surface 49 may be positioned between the electrode coupling portions 41 and the support surface 45. The second inclined surface 49 may extend in the axial direction and in the radial direction from the electrode coupling portions 41 to the support surface 45. The second inclined surface 49 may have a substantially constant slope. The can lid 40 may include a mating surface 48, a curved surface 47, a first inclined surface 46, a support surface 45, a second inclined surface 49, and an electrode coupling portion 41 in that order in the radial direction from the outer side of the can lid 40 toward the center of the can lid 40. The second inclined surface 49 may have a steeper slope than the first inclined surface 46. Accordingly, the radial length of the support surface 45 and the electrode coupling portion 41 may maximized.

The vent notch portion 60 may be near the center of the support surface 45 in the radial direction so the vent notch portion 60 is spaced apart from the first inclined surface 46 and the second inclined surface 49 in the radial direction. In such aspects, even if the support surface 45 is pressed, the pressing force is transmitted to the first inclined surface 46 and the second inclined surface 49 and does not affect the vent notch portion 60. Therefore, the force applied when the can lid 40 is bonded to the cell housing 200 and the electrode assembly 100 does not deform the vent notch portion 60.

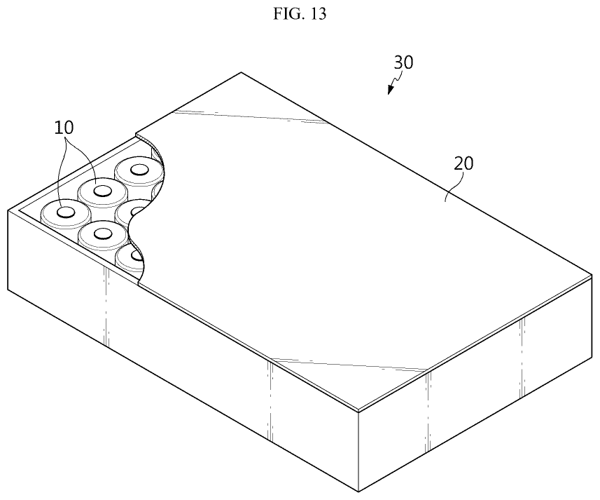

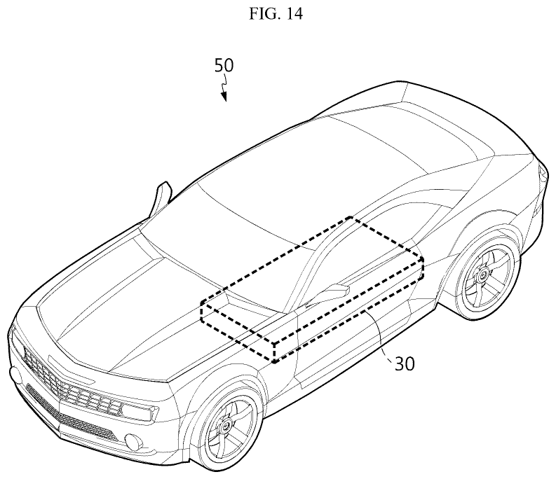

FIG. 13 is a perspective view schematically depicting a battery pack 30 according to an aspect of the present disclosure. FIG. 14 is a schematic depiction of a vehicle including a battery pack 30 according to an aspect of the present disclosure.

The battery cell 10 described above may be accommodated in the housing 20 of the battery pack 30 as shown in FIG. 13. The battery pack 30 may be configured using a plurality of battery modules, which are an intermediate form of assembly that can contain multiple battery cells 10. Thus, the battery pack 30 may be made up of an arrangement of a plurality of battery modules each containing multiple battery cells 10, or the battery pack 30 may be configured directly by assembling a plurality of battery cells 10 without intervening battery modules, as illustrated in FIG. 13. Since the battery cell 10 has a large volume by itself, there is no particular difficulty in implementing the battery pack 30 even without using an intermediate structure called a battery module. And, since the negative electrode of the battery cell 10 may be connected through the can lid 300, the internal resistance is low and the energy density is high. Additionally, since the vent notch portion is provided on the can lid 300 and does not occupy a separate space, energy density may be further improved. Accordingly, the energy density of the battery pack 30 including the battery cell 10 may be improved.

In one or more aspects, a plurality of battery cells 10 may be included in the battery pack 30. The battery cells 10 are arranged in a predetermined number of rows, and may be arranged so that both the positive terminal and the negative terminal in each battery cell 10 face an upper side of the battery pack 30. In one or more aspects, both the positive and negative electrodes of the plurality of battery cells 10 may be connected in one direction, thereby simplifying the electrical connection structure. Through this, energy density may be improved by increasing the number of battery cells 10 that may be mounted in the same space, and the electrical wiring work may be simplified. Therefore, the space efficiency may be improved, and the electrical wiring efficiency may be improved, so that there is a significant improvement in the process of assembling electric vehicles, as well as during the assembly and maintenance of the battery pack 30. Additionally, each of the battery cells 10 may have a greater energy density than the prior art, as described above. The battery pack 30 with the increased energy density may store the same energy while reducing the volume and mass of the battery pack 30.

Therefore, if the battery pack 30 to which such battery cells 10 are applied is mounted on a vehicle 50, such as the vehicle 50 using electricity as an energy source as illustrated in FIG. 14, the mileage of the vehicle 50 may be further increased in proportion to the energy consumed.

The vehicle 50 according to aspects of the present disclosure may include the battery pack 30. The vehicle 50 may be a hybrid vehicle or an electric vehicle. The vehicle 50 according to aspects of the present disclosure may further include various other components included in the vehicle in addition to the battery pack 30. For example, the vehicle 50 according to the present disclosure may further include a vehicle body, a motor, a control device such as an electronic control unit (ECU), or the like in addition to the battery pack 30 according to aspects of the present disclosure.

In one or more aspects, electrical wiring may be performed on the bottom of the cell housing 200, the side of the cell housing 200 where the terminal 400 is positioned, and may not be performed on the can lid 300 positioned at the opposite side of the cell housing 200. This may maximize the effectiveness of the vent notch portion 380 on the can lid 300. Additionally, if a heat sink, a cooling plate, or a tray is positioned on the can lid 300 side of the cell housing 200, the purpose of assembly and cooling may be effectively achieved without interference from the electrical wiring connection. In addition, the gas discharged from the inside of the secondary battery will desirably be discharged downward by assembling the vent notch portion 380 to face downward. In one or more aspects, the secondary battery is mounted below the passenger compartment of a vehicle. Thus if the gas were to be discharged upward from the secondary battery, it may cause harm to the passengers. The battery cell 10 of the present disclosure, on the other hand, may effectively discharge high-pressure gas inside the secondary battery in a downward direction, away from the passenger compartment. This may reduce the likelihood that gas emitted from the secondary battery may harm the passengers of the vehicle, and thus may improve the safety of the vehicle. Additionally, the gas emitted from the secondary battery is less likely to damage the electrical wiring connections at the top of the battery cell.

Aspects of the present disclosure have been described with regard to the drawings, but the present disclosure is not limited thereto. A variety of modifications and variations may be made thereto by those having ordinary skill in the technical field pertaining to the present disclosure within the technical ideas of the present disclosure and the scope of the appended claims and their equivalents. Therefore, the aspects disclosed above should be considered from an illustrative perspective rather than a limiting perspective. That is, the scope of the true technical idea of the present disclosure is shown in the claims, and all differences within the scope of equivalents should be construed as being included in the present disclosure.

### DESCRIPTION OF REFERENCE NUMERALS

10: Battery cell
20: Housing
30: Battery pack
40: Can lid
41: Electrode coupling portion
42: Injection port
43: Protrusion
44: Outer surface
45: Support portion
46: Inclined surface
47: Curved surface
48: Mating portion
49: Second inclined portion
50: Vehicle
60: Vent notch portion
100: Electrode assembly
112a, 112b: Uncoated portion
200: Cell housing
205: Side wall portion
210: Opening
220: Bottom portion
300: Can lid
310: Electrode coupling portion
311: Extended portion
320: Flat portion
321: Bent portion
330: Plug
331: Protrusion
332: Extension portion
340: Plug coupling portion
341: Insertion portion
342: Seating portion
350: Bridge
360: Picking portion
361: Picking area
370: Edge portion
371a: Curved surface
371b: Inclined surface
372: Mating surface
380: Vent notch portion(s)
390: Support surface
400: Terminal
500: Terminal gasket
600: positive electrode current collector plate
700: Insulator
H: Injection port
C: Winding center hole

1. A battery cell comprising:
an electrode assembly;
a cell housing comprising a sidewall portion, an opening at a first end of the cell housing in an axial direction, and a bottom portion at a second end of the cell housing in the axial direction, wherein the cell housing accommodates the electrode assembly therein; and
a can lid comprising an edge portion and an electrode coupling portion;
wherein the can lid is positioned to cover the opening of the cell housing,
wherein the electrode coupling portion of the can lid extends further into an interior of the cell housing in the axial direction than the edge portion of the can lid,
wherein the electrode coupling portion of the can lid contacts the electrode assembly, and
wherein the edge portion of the can lid is spaced apart from the electrode assembly along the axial direction.

2. The battery cell of claim 1, wherein the edge portion of the can lid is joined to the sidewall portion of the cell housing at the first end of the cell housing.

3. The battery cell of claim 1, wherein the can lid is electrically connected to the sidewall portion of the cell housing.

4. The battery cell of claim 1, wherein the can lid comprises a plurality of electrode coupling portions and each of the plurality of electrode coupling portions contacts the electrode assembly.

5. The battery cell of claim 4, wherein the plurality of electrode coupling portions are spaced apart from each other in a circumferential direction.

6. The battery cell of claim 5, wherein the can lid comprises a plurality of bridges and each bridge of the plurality of bridges is between adjacent electrode coupling portions of the plurality of electrode coupling portions in the circumferential direction.

7. The battery cell of claim 4, wherein the plurality of the electrode coupling portions are arranged rotationally symmetrically about a center of the can lid.

8. The battery cell of claim 1, wherein the can lid further comprises an injection port at a center of the can lid.

9. The battery cell of claim 8, wherein the can lid further comprises a flat portion surrounding the injection port, and wherein the flat portion is between the injection port and the electrode coupling portion in a radial direction.

10. The battery cell of claim 1, wherein the can lid further comprises a vent notch portion between the electrode coupling portion and the edge portion in a radial direction.

11. The battery cell of claim 1, wherein the vent notch portion is on a surface of the can lid that faces away from the electrode assembly in the axial direction.

12. The battery cell of claim 1, wherein the edge portion of the can lid comprises a mating surface, a curved surface, and an inclined surface that form a U-shaped bent portion.

13. The battery cell of claim 12, wherein an outer edge of the can lid in a radial direction comprises the mating surface.

14. The battery cell of claim 13, wherein the mating surface extends in the axial direction and the mating surface is in direct contact with an inner circumferential surface of the sidewall portion of the cell housing.

15. The battery cell of claim 1, wherein the electrode assembly comprises a first electrode, a second electrode, and a separator interposed between the first electrode and the second electrode.

16. The battery cell of claim 15, wherein the first electrode comprises a first uncoated portion, the second electrode comprises a second uncoated portion, and the second uncoated portion of the second electrode is directly connected to the electrode coupling portion of the can lid.

17. The battery cell of claim 16, wherein the bottom portion of the cell housing comprises a through hole, a terminal extends through the through hole of the bottom portion of the cell housing, and the terminal is electrically connected to the first uncoated portion of the first electrode.

18. The battery cell of claim 17, wherein the battery cell is a cylindrical battery cell.

19. A battery pack comprising the battery cell of claim 1.

20. A vehicle comprising the battery pack of claim 19.
